(19) United States
(12) Patent Application Publication
(10) Pub. No.: US 2011/0128565 A1
(43) Pub. Date: Jun. 2, 2011

(54) IMAGE PROCESSING APPARATUS, CONTROL METHOD OF IMAGE PROCESSING APPARATUS, AND RECORDING MEDIUM

(75) Inventor: Bungo Shimada, Tokyo (JP)

(73) Assignee: CANON KABUSHIKI KAISHA, Tokyo (JP)

(21) Appl. No.: 12/913,320

(22) Filed: Oct. 27, 2010

(30) Foreign Application Priority Data
Dec. 2, 2009 (JP) 2009-274956

(51) Int. Cl. G06F 3/12

(52) U.S. Cl. 358/1.13

(57) ABSTRACT

An includes a determination unit, a reading unit, a transmission unit, a receiving unit, and a printing unit. The determination unit is configured to determine an external apparatus corresponding to a user authenticated by an authentication unit for authenticating a user, as an external apparatus to be used in a plurality of the external apparatuses. The reading unit is configured to read a document and generate image data. The transmission unit is configured to transmit the generated image data to the determined external apparatus. The receiving unit is configured to receive image data from the external apparatus, where image processing is performed to the image data in the external apparatus. The printing unit is configured to print using the received image data.

### BACKGROUND OF THE INVENTION

1. Field of the Invention

The present invention relates to an image processing apparatus, a control method of the image processing apparatus, and a recording medium storing a program.

2. Description of the Related Art

There is a technique in which an image processing apparatus, such as a copying machine, performs a copying operation cooperating with an external apparatus such as a personal computer (PC), and realizes an extended copy function which cannot be performed singly by the image processing apparatus. For example, Japanese Patent Application Laid-Open No. 8-186677 discusses a configuration in which an extended copy function is executed not in an image processing apparatus but in an external apparatus. In such a configuration, the image processing apparatus can be simplified, and as a result of this, the apparatus can be provided at a low cost.

However, in a conventional technique, an external apparatus such as a PC used by the image processing apparatus is a designated PC or server which is previously registered in the image processing apparatus. Therefore, under an environment such as a local area network (LAN) which is connected with a plurality of image processing apparatuses via a network, there have been following problems. That is, a plurality of the image processing apparatuses is often set so as to perform a process cooperating with an identified external apparatus and, in such a case, an operation load is concentrated on the set external apparatus, so that a problem of performance decrease occurs. Further, when a user cannot use the set external apparatus because power supply is OFF or the apparatus is in trouble, the cooperation processing is limited.

By contrast, it is conceivable that a user does not previously designate one external apparatus used by an image processing apparatus but registers a plurality of external apparatuses, and selects one of the external apparatuses each time when he carries out corporation processing. However, in such a method, since a user must select the external apparatus each time when he carries out the cooperation processing, an operation is cumbersome, and the method is thus not necessarily easy to use for the user.

### SUMMARY OF THE INVENTION

According to an aspect of the present invention, an apparatus includes a determination unit configured to determine an external apparatus corresponding to a user authenticated by an authentication method for authenticating a user, as an external apparatus to be used in a plurality of the external apparatuses, a reading unit configured to read a document and generate image data, a transmission unit configured to transmit the generated image data to the determined external apparatus, a receiving unit configured to receive image data from the external apparatus, where image processing is performed to the image data in the external apparatus, and a printing unit configured to print using the received image data.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a system configuration and a configuration of each apparatus in the exemplary embodiment of the present invention.

FIG. 2 illustrates a schematic view of an operation unit included in a copying machine.

FIGS. 3A, 3B, 3C, and 3D illustrate screen examples displayed on a liquid crystal display (LCD).

FIG. 4 illustrates a screen example displayed on the LCD.

FIGS. 5A, 5B, and 5C illustrate examples using an extended copy function in the exemplary embodiment of the present invention.

FIG. 6 is a flowchart illustrating processing executed in a copying machine.

FIG. 7 is a flowchart illustrating processing executed in a copying machine.

FIG. 8 is a flowchart illustrating processing executed in a copying machine.

FIG. 9 is a flowchart illustrating processing executed in an external apparatus.

FIG. 10 is a table illustrating contents of a user information database.

FIG. 11 is a table illustrating contents of a profile database.

FIG. 12 is a flowchart illustrating processing executed in an external apparatus.

### DESCRIPTION OF THE EMBODIMENTS

Various exemplary embodiments, features, and aspects of the invention will be described in detail below with reference to the drawings.

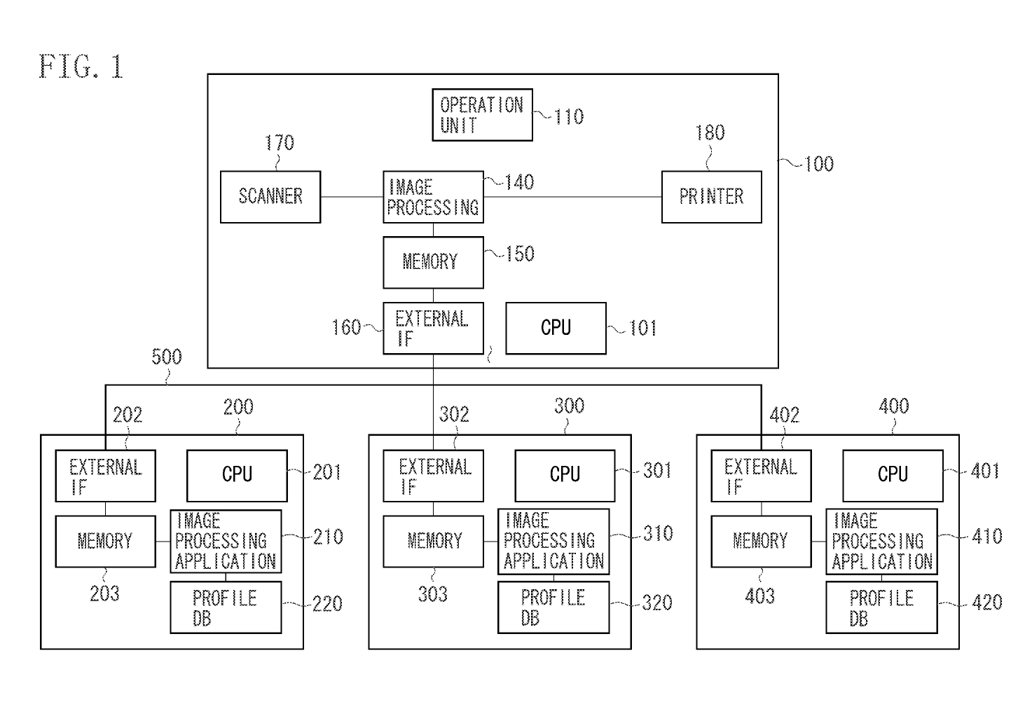

FIG. 1 is a block diagram illustrating a system configuration and a configuration of each apparatus in a first exemplary embodiment. Each block in each apparatus indicates a hardware module and a software module which are necessary to describe the present exemplary embodiment. An arrow between blocks indicates a flow of data or an instruction.

In FIG. 1, a copying machine 100 is an image processing apparatus. A central processing unit (CPU) 101 executes a program of a software module in the copying machine 100, and controls each hardware module. An operation unit 110 notifies information to a user, and transmits a user instruction to each block in the copying machine 100. A scanner unit 170 reads a document, generates image data, and outputs the generated image data to following step modules such as an image processing unit 140. The image processing unit 140 performs image processing of image data generated by the scanner unit 170. A memory 150 stores image data processed by the image processing unit 140 and attributes of the image data. An external interface (IF) 160 communicates the image data and the attributes of the image data, which are stored in the memory 150, with an external apparatus. A printing unit 180 performs printing based on the image data, and prints image data stored in the memory 150. At the printing time, the image processing unit 140 performs image processing for printing if necessary. In the block diagram of the copying machine 100 in the present exemplary embodiment, the scanner unit 170 and the printing unit 180 are configured inside the copying machine 100. However, one or both of these units can be set up outside the copying machine 100.

An external apparatus 200 includes CPU 201. The CPU 201 executes programs of software modules in the external apparatus 200, and controls each hardware module. An external IF 202 communicates with other external apparatuses and the copying machine 100. A memory 203 stores data input via the external IF 202, and temporarily stores data to be transmitted via the external IF 202. An image processing application 210 performs image processing according to setting of a profile database (DB) 220, and management of profile data. Data in which image processing is performed is transmitted to the copying machine 100 via the external IF 202. The profile DB 220 stores profile data indicating that what kind of image processing is performed for each user. The profile data will be described in detail below. In addition, the image processing application 210 is a software module, actually installed in the external apparatus 200, and stored in the memory 203. Further, data indicated by the profile DB 220 is also actually stored in the memory 203. In FIG. 1, the image processing application 210 and the profile DB 220 are illustrated together with the hardware modules from a point of view of description.

External apparatuses 300 and 400 have a similar internal configuration to the external apparatus 200. In the present exemplary embodiment, the external apparatus 200 indicates a server, and the external apparatus 300 and the external apparatus 400 indicate PC of general users.

In a system of the exemplary embodiment, the copying machine 100 and the external apparatuses 200, 300, and 400 are connected to communicate with each other via a network 500 such as LAN. In addition, it is needless to say that, on the network 500, other apparatuses not illustrated can be connected.

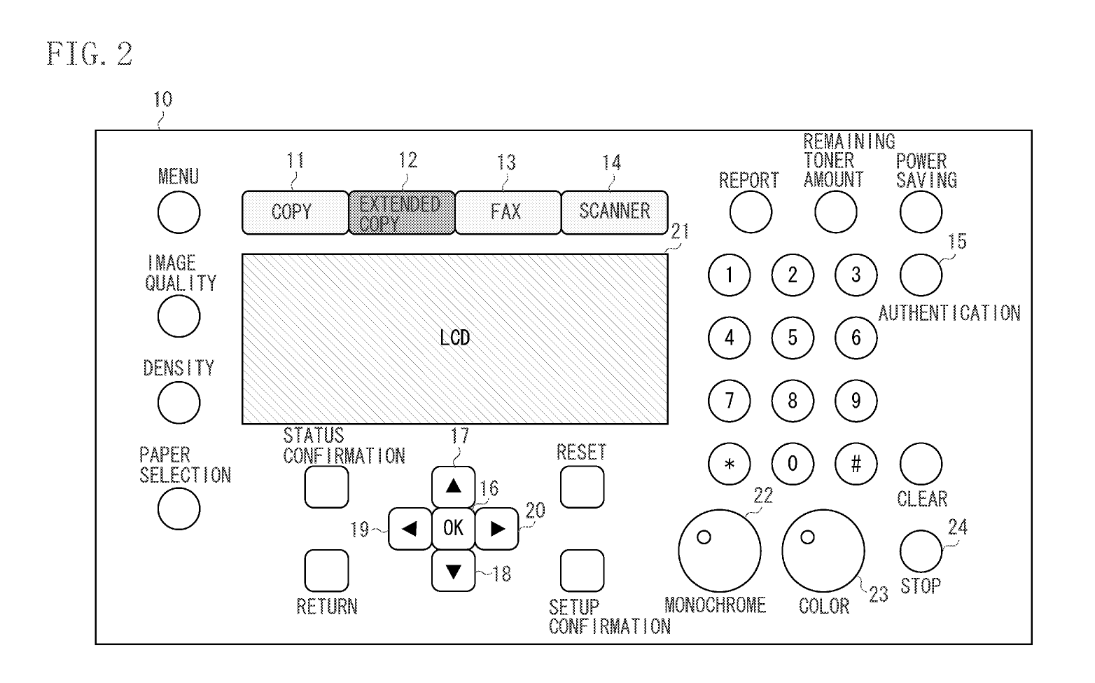

FIG. 2 is a schematic view illustrating the operation unit 10 included in the copying machine 100. A “COPY” key 11, a “EXTENDED COPY” key 12, a “FAX” key 13, and a “SCAN” key 14 are function keys of each function. When a user presses these function keys, a basic screen of its function is displayed on a LCD 21. Since the function key is flashed, the user can recognize the selected function. The example in FIG. 2 indicates that the “EXTENDED COPY” key is selected. The “COPY” function is a function which performs necessary image processing to image data generated by the scanner 170 in the image processing unit 140 and prints the image data by the printer 180. The “EXTENDED COPY” function is a function which transmits image data generated by the scanner 170 to an external apparatus, receives data image-processed by the image processing application 210 in the external apparatus, and prints the image data by the printing unit 180. In other words, the extended copy function is a function not executing copy processing by the copying machine 100 on a stand-alone basis, but executing the copy processing by cooperating with an external apparatus. By including this function, the copying machine 100 in the exemplary embodiment can perform image processing, which cannot be performed by the image processing unit 140 in the copying machine 100, utilizing the image processing application 210 in the external apparatus. As an example of image processing which cannot be performed by the image processing unit 140, an image processing of the numbering or the watermark combining, which will be described below, is considered, but other image processing is allowable. Descriptions of the “FAX” function and the “SCANNER” function will be omitted. An authentication key 15 is used in an operation at a time of log-in/log-out by a user. An OK key 16 is used when a user selects a desired item in items displayed on the LCD. Vertical and horizontal arrow keys 17 to 20 are used when a user moves the item to be selected on the LCD. A LCD 21 displays an operation screen. A monochrome start key 22 is flashed when it can be pressed. Similarly, a color start key 23 is flashed when it can be pressed. A stop key 24 is pressed by a user when a user stops an executing job.

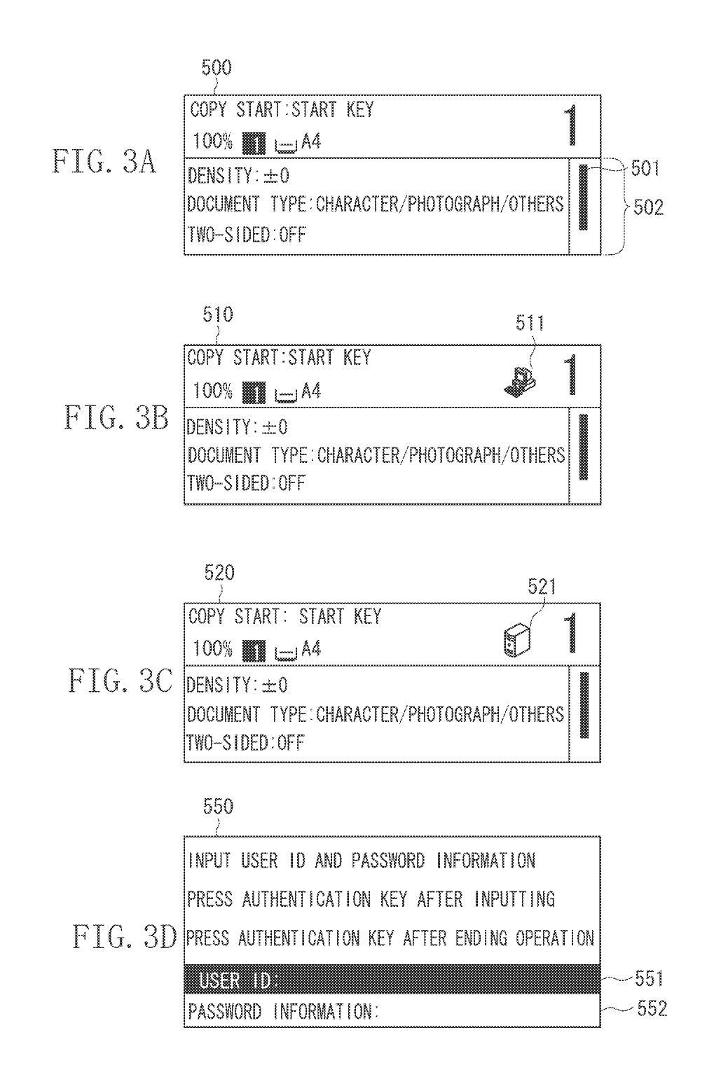

Examples of a screen displayed on the LCD 21 will be described with reference to FIGS. 3A and 3B. FIG. 3A illustrates a screen 500 displayed on the LCD 21 when the “COPY” key 11 is pressed. The screen 500 is a basic screen of a copy, and configured with five lines. A current status is displayed on the first line. A copying magnification and information of a selected paper feed stage are displayed on the second line. The number of copies is displayed with a large numeral in a right end of the first line and the second line. Operation mode items 502 which can be designated for a copy job are displayed from the third line to the fifth line. When all of the items 502 cannot be displayed, the screen 500 displays a scroll bar 501 at a right end.

FIG. 3B illustrates a screen 510 displayed on the LCD 21 when the “EXTENDED COPY” key 12 is pressed. FIG. 3B illustrates an example that the external apparatus 300 or the external apparatus 400, which is a PC of general users, is selected as an external apparatus which becomes a target for cooperation processing when a user performs an extended copy. In such a case, a PC connection icon 511 is displayed on the screen 510, and the user can recognize that the external apparatus used as the cooperation target is a PC of general users. FIG. 3C is a screen 520 displayed on the LCD 21 when the “EXTENDED COPY” key 12 is pressed. FIG. 3C illustrates an example that the external apparatus 200, which is a server, is selected as an external apparatus, which becomes a target for cooperation processing when a user performs the extended copy. In such a case, a server connection icon 521 is displayed on the screen, and a user can recognize that the external apparatus to be used as a cooperation target is a server.

FIG. 3D illustrates an authentication screen 550 displayed on the LCD 21. When a user authentication function is effective in the copying machine 100, the authentication screen 550 is displayed and prompts a user to perform log-in processing (input of user identification (ID) and password information). A user sets a selection item on the screen 550 to a user ID 551, and inputs user ID by numeric keypads. Further, the user sets the selection item to password information 552, and inputs password information by numeric keypads. Then, the user presses an authentication button 15. After authentication succeeds and log-in is completed, anyone of the screens illustrated in FIGS. 3A, 3B, and 3C is displayed if a user uses the copy function or the extended copy function. In addition, in the present exemplary embodiment, a user operates the operation unit, and inputs the user ID and the password information on the screen illustrated in FIG. 3D. However, a user can input this information by other methods, such as a non-contact integrated circuit (IC) card, and perform user authentication.

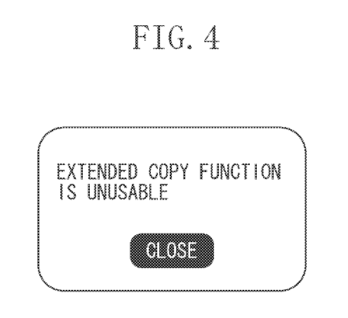

FIG. 4 illustrates a screen displayed on the LCD 21 when all of the external apparatuses 200, 300, and 400 are unusable although the extended copy function is selected. When the OK key 16 is pressed, the screen is transferred to a status that the “COPY” key 11 is selected.

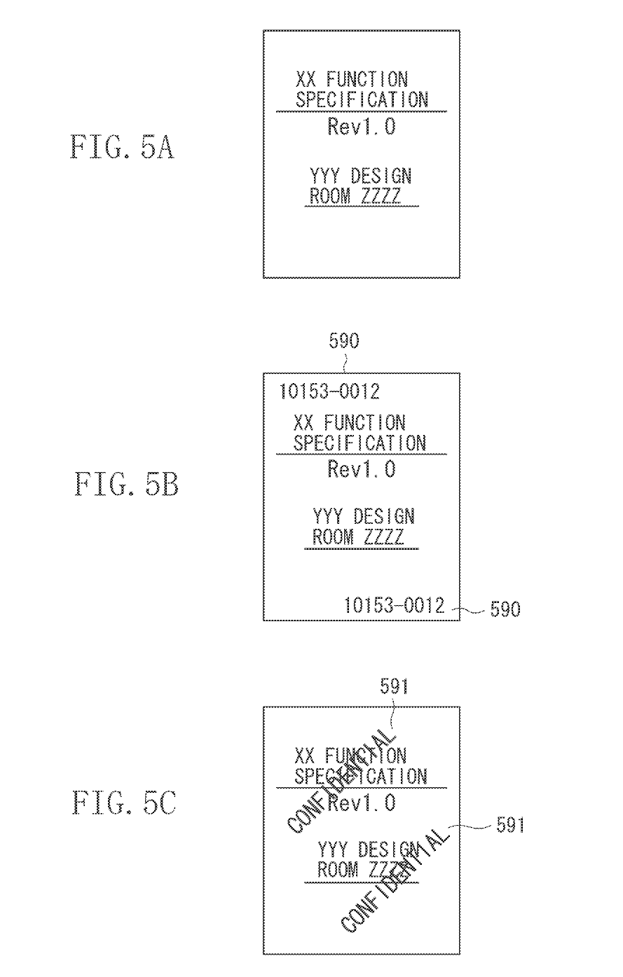

Example use of the extended copy function in the present exemplary embodiment will be described below with reference to FIGS. 5A and 5B. FIG. 5A illustrates an example of a document to be copied. When the document is copied, a copy of the document can be obtained. FIG. 5B illustrates an example when the document in FIG. 5A is performed by the extended copy. FIG. 5B is different from FIG. 5A in that the user ID and the number of copies are numbered in a portion 590. The image processing of the numbering is performed by the image processing application included in the external apparatus 200 (or the external apparatus 300 or 400). FIG. 5C illustrates another example when the document in FIG. 5A is performed by the extended copy. A watermark is combined at a portion 591. The watermark (electronic watermark) is a technique to write specific information, hardly affecting an image quality in the image. The image data, in which the watermark data is combined, is not apparently different from the original data. However, when the image data, in which the watermark data is combined, is read by special electronic watermark detection software, embedded information, such as a name of a writer or the number of copies, is displayed. The image processing of the watermark combining is performed by the image processing application included in the external apparatus 200 (or the external apparatus 300 or 400). Therefore, even when there are not functions of the numbering and the watermark combining in functions in the image processing unit 140 in the copying machine 100, the image processing apparatus can perform theses image processing in the image processing application in the external apparatus, by using the extended copy function. In addition, contents of the image processing executed by the extended copy function in the external apparatus, which is a cooperation destination, can include other contents than these contents described in the present embodiment.

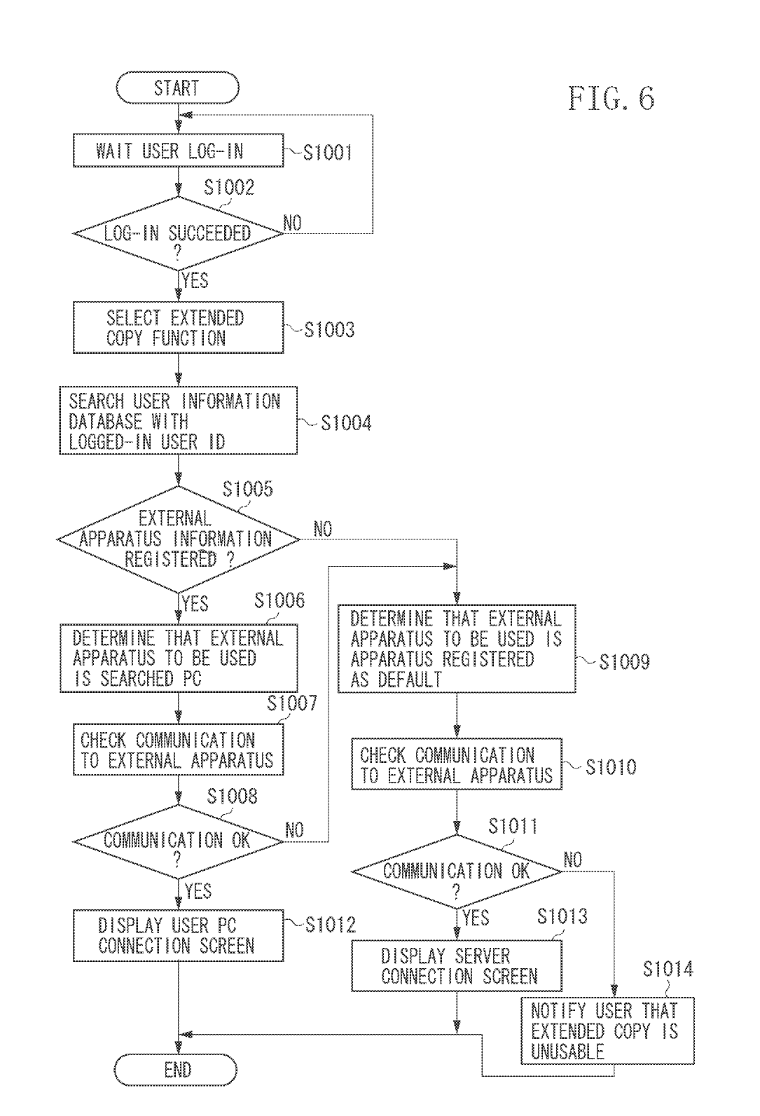

FIG. 6 is a flowchart illustrating processing executed in the copying machine 100 when a user performs log-in processing. The CPU 101 executes programs stored in the memory 150 in the copying machine 100 and processes each step in FIG. 6.

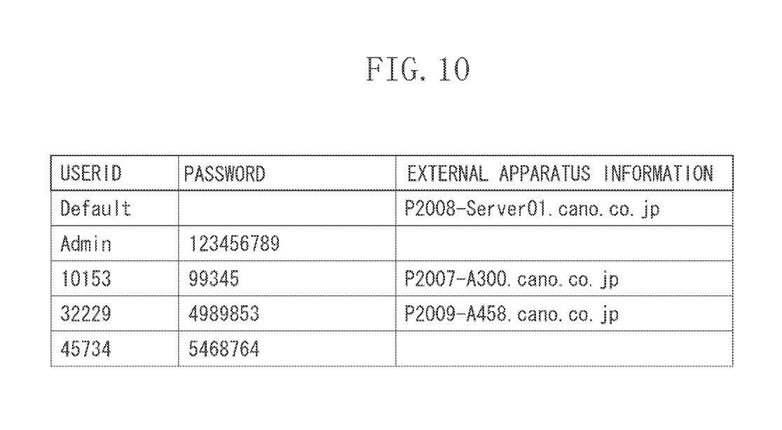

In step S1001, the copying machine 100 receives log-in processing of a user. More specifically, the copying machine 100 receives user ID and password which are input by the user using numeric keypads on the screen illustrated in FIG. 3D. In step S1002, the copying machine 100 performs user authentication processing by comparing the received user ID and password information with the user ID/password registered in the user information database. FIG. 10 illustrates one example of the user information data base stored in the memory 150 in the copying machine 100. In step S1002, when the combination of the received user ID and password information is registered in the user information data base, the copying machine 100 permits the user to perform log-in to the copying machine 100, and processing proceeds to step S1003. When the combination of the received user ID and password information is not registered, the copying machine 100 indicates on the LCD 21 that the user ID and the password information are not registered, and processing returns to a status of waiting log-in. In step S1003, the copying machine 100 receives a selection of the “EXTENDED COPY” key 12 by a user, and selects the extended copy function. In addition, step S1004 and following steps are processing executed according to the selection of the extended copy function in step S1003. Therefore, when the other function (“COPY” or “FAX”) is selected, the copying machine does not execute the processing after step S1004, and displays a screen according to these selected functions.

In step S1004, the copying machine 100 searches the user information database, using the user ID (or the user ID and the password) received in step S1001. In step S1005, the copying machine 100 refers to the searched record in the user information data base and determines whether the external apparatus information is registered relating to the user ID. In the example illustrated in FIG. 10, the external apparatus information “P2007-A300.cano.co.jp” and “P2009-A458.cano.co.jp” is registered relating to each of the user ID “10153” and “32229”. Therefore, when the user ID received in step S1001 is anyone of “10153” and “32229”, the copying machine 100 determines that the external apparatus information is registered, and processing proceeds to step S1006. On the other hand, the external apparatus information is not registered relating to the user ID “Admin” and “45734”. Therefore, when the user ID received in step S1001 is any one of “Admin” and “45734”, the copying machine 100 determines that the external apparatus information is not registered, and processing proceeds to step S1009.

In step S1006, the copying machine 100 determines the external apparatus indicated by the external apparatus information searched in step S1004 as the external apparatus to be used in the extended copy function. In step S1007, the copying machine 100 communicates with the external apparatus determined in step S1006, using the external apparatus information of the external apparatus. In the example in FIG. 10, since a host name (domain name) is registered as the external apparatus information, the copying machine 100 acquires an internet protocol (IP) address of the host name from a domain name system (DNS) server, and communicates with the external apparatus, using the acquired IP address. In addition, the information registered as the external apparatus information is used for communicating with the external apparatus, and is not limited to the host name. Other information, e.g., an IP address or media access control (MAC) address, can be used. In step S1008, the copying machine 100 determines whether the communication with the external apparatus succeeds in step S1007. When the communication is in error, the external apparatus is currently unusable because the external apparatus is in trouble or a power supply is OFF, and processing proceeds to step S1009. On the other hand, when the copying machine 100 determines that the communication succeeds, processing proceeds to step S1012. In step S1012, the copying machine 100 displays a screen of the extended copy using the PC connection icon 511 as illustrated in FIG. 3B. By this screen, a user can easily recognize that the external apparatus (usually, his own PC) registered relating to the own user ID is selected as the cooperation destination external apparatus.

When the copying machine 100 determines in step S1005 that the external apparatus information is not registered or the copying machine 100 can not communicate with the external apparatus in step S1008, processing proceeds to step S1009. In step S1009, the copying machine 100 determines an external apparatus to be used in the extended copy function, as the external apparatus default-registered in the copying machine 100 as. More specifically, the copying machine 100 refers to the user information database, and refers to the external apparatus information in which the user ID corresponds to a record of “Default”. In the example in FIG. 10, the user ID “Default” corresponds to the external apparatus information “P2008-Server01.cano.co.jp”. In step S1010, the copying machine 100 communicates with the external apparatus determined in step S1009, using the external apparatus information of the external apparatus. An example of the communication method is described above. In step S1011, the copying machine 100 determines whether the communication with the external apparatus succeeds in step S1010. When the communication is in error, the external apparatus is currently unusable because the external apparatus is in trouble or a power supply is OFF, and processing proceeds to step S1014. On the other hand, when the copying machine 100 determines that the communication succeeds, processing proceeds to step S1013. In step S1013, the copying machine 100 displays a screen of the extended copy using the server connection icon 521 as illustrated in FIG. 3C. By this screen, a user can easily recognize that the server is selected as the cooperation destination external apparatus. On the other hand, in step S1014, the copying machine 100 displays the screen illustrated in FIG. 4 on the LCD 21, and notifies a user that the extended copy function is unusable because the cooperation destination external apparatus does not exist.

The above is the processing flow when the user logs in to the copying machine 100. Accordingly, in the present exemplary embodiment, if an external apparatus corresponding to a log-in user (e.g., a PC always used by the user) is previously registered in the copying machine 100, only by performing log-in, the user can automatically select the external apparatus as the external apparatus to be used when the user uses the extended copy function. Therefore, the user can save time and effort for manually selecting the external apparatus every time when the user uses the extended copy function. Further, since different external apparatuses can be registered relating to each user ID, the load can be prevented from concentrating on one external apparatus when using the extended copy function. Furthermore, when the external apparatus registered corresponding to the user ID is unusable because the external apparatus is in trouble or a power supply is OFF, the external apparatus (e.g., a server) is selected by default, so that the copying machine 100 can reduce much more a situation that the extended copy function is unusable.

In addition, in the example illustrated in FIG. 6, the processing after step S1004 is described as the processing executed in response to the selection of the extended copy function. However, the processing after step S1004 can be always executed in response to log-in processing of a user. In such a case, the copying machine 100 generates data for displaying in steps S1012, S1013, and S1014 without displaying the screens, and then displays the generated screen in response to a selection of the extended copy function by the user. In the example in FIG. 6, the copying machine 100 executes user authentication processing using the user ID and the password. However, an external apparatus (e.g., server) can perform the user authentication processing. More specifically, the copying machine 100 transmits the input user ID and password to a predetermined external authentication server, and receives a result of the user authentication processing in the authentication server. Then, the copying machine 100 can switch between permission and prohibition of log-in depending on the result.

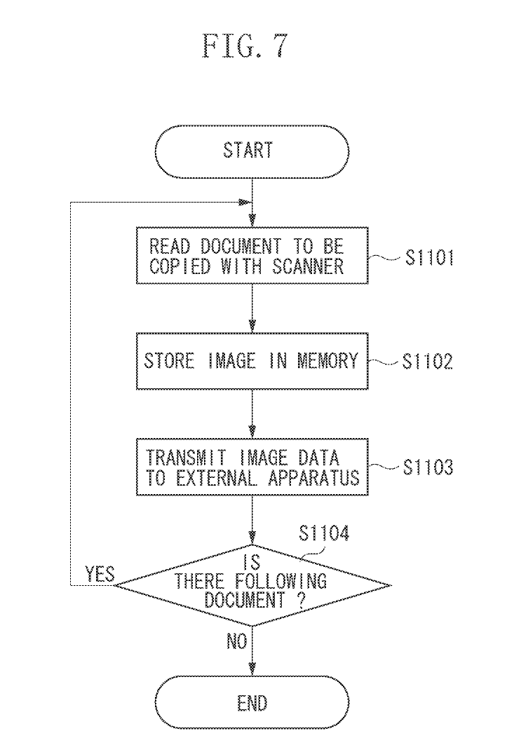

FIG. 7 is a flowchart illustrating processing executed when the extended copy function is selected and the start key (22 or 23) is pressed in the copying machine 100. The CPU 101 executes programs stored in the memory 150 in the copying machine 100 and processes each step in FIG. 7.

In step S1101, the copying machine 100 reads a document to be copied by the scanner 170. In step S1102, the copying machine 100 stores, in the memory 150, image data generated from the read document. In this step, the copying machine 100 performs image processing using the image processing unit 140, as needed. In step S1103, the copying machine 100 transmits image data stored in the memory 150 to the external apparatus determined in the flowchart in FIG. 6 via the external IF 160. In addition, the copying machine 100 attaches user ID to the image data to be transmitted as additional information. Further, the copying machine 100 transmits a profile number as needed, as described below. In step S1104, the copying machine 100 determines whether there is image data in a next page. When there is image data in the next page, the processing returns to step S1101. When there is not image data in the next page, the processing of the flowchart ends. In addition, in the example in FIG. 7, the processing of step S1104 and the processing of step S1103 are illustrated in series. In other words, reading and transmitting are sequentially executed. However, step S1103 and step S1104 can be processed in parallel. Further, reading and transmitting are repeated for every single page. However, the copying machine 100 can also read all pages, generate image data, store the image in the memory, and collectively transmit the image data to the external apparatus.

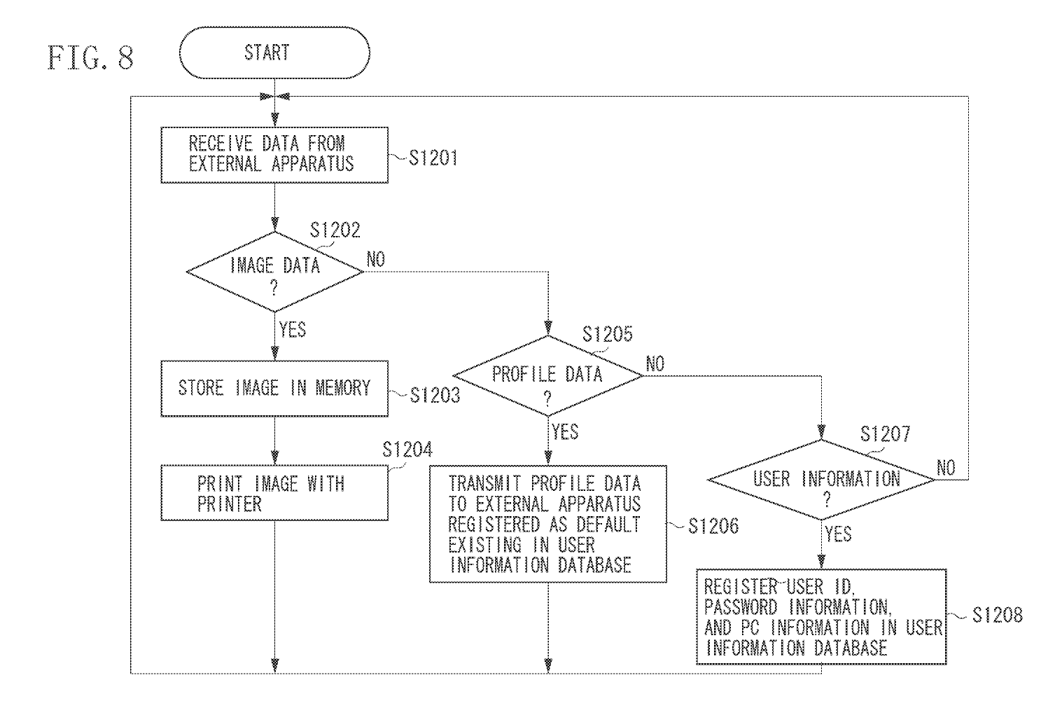

FIG. 8 is a flowchart illustrating processing executed when the copying machine 100 receives data transmitted from the external apparatus. The CPU 101 executes programs stored in the memory 150 in the copying machine 100 and processes each of the steps in FIG. 8.

In step S1201, the copying machine 100 receives data transmitted from the external apparatus. In step S1202, the copying machine 100 determines whether the received data is image data to be printed. When the copying machine 100 determines that the received data is image data, processing proceeds to step S1203. In step S1203, the copying machine 100 stores the received image data in the memory 150. In step S1204, the copying machine 100 performs image processing on the image data stored in the memory 150 by the image processing unit 140 as needed, and prints the image data by the printing unit 180. Then, processing returns to step S1202, and turns to a status to receive the next data.

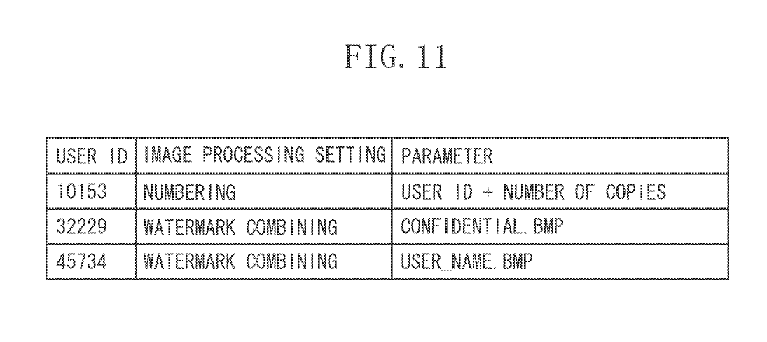

When the received data is not image data, processing proceeds to step S1205. In step S1205, the copying machine 100 determines whether the received data is profile data. The profile data includes image processing setting relating to the user ID and parameters, and is registered in a profile database in the external apparatus. The image processing application in the external apparatus executes image processing in accordance with the profile data registered in the profile database. In other words, if a user previously registers profile data in a profile database, the user can cause an external apparatus to execute desired image processing only by selecting a desired profile in the copying machine 100 when using the extended copy function. As described below, when profile data is registered in the profile database, the external apparatus transmits the profile data to the copying machine 100. In step S1205, the copying machine 100 determines whether the copying machine 100 receives the profile data transmitted from the external apparatus. When the copying machine 100 determines that the copying machine 100 receives the profile data, processing proceeds to step S1206. In step S1206, the copying machine 100 transfers the received profile data to the external apparatus 200 (server) which is registered corresponding to the user ID “Default” in the user information database. The reason for this is that, as described in FIG. 6, when the external apparatus corresponding to the user ID is unusable, the profile data needs to be registered also in the server so that the copying machine 100 performs extended copy using the external apparatus 200 (server) registered as default. FIG. 11 illustrates an example of data registered in the profile database 220 in the external apparatus 200 (server). In the example in FIG. 11, three profiles are registered, and respectively correspond to user ID “10153”, “32229”, and “45734”. If image data and the user ID “10153” are transmitted from the copying machine 100 to the external apparatus 200, the image processing application 210 in the external apparatus 200 performs, on the image data, image processing of numbering the user ID and numbers of copies. In the example in FIG. 11, only one profile (image processing setting and parameters) is registered to one user ID. However, it is possible to register a plurality of profiles to one user ID. In such a case, these profiles can be distinguished by relating these profiles to profile numbers in addition to the user ID. Further, in such a case, when a user executes the extended copy in the copying machine 100, the user selects a desired profile in a list of profiles displayed on the LCD 21. The copying machine 100 transmits the image data, the user ID, and the selected profile number to the external apparatus. After processing of step S1206, processing returns to step S2101, and the copying machine 100 turns to a status to receive next data.

When the received data is not either image data or profile data, processing proceeds to step S1207. In step S1207, the copying machine 100 determines whether the received data is user information. The user information is data registered in the user information database illustrated in FIG. 10, and includes user ID, password, and external apparatus information. In step S1208, the copying machine 100 registers the received user information in the user information database stored in the memory 150. Then, processing returns to step S1201, and the copying machine 100 turns to a status to receive the next data. In addition, when the received data is other data (NO in step S1207), the copying machine 100 executes predetermined processing corresponding to the received data. However, in the present exemplary embodiment, descriptions of the processing corresponding to the other data are omitted.

As described with reference to FIGS. 7 and 8, the copying machine 100 of the present exemplary embodiment transmits, to the external apparatus, the image data generated from the document read by the scanner unit, receives the image data in which image processing is performed in the external apparatus, and prints the received image data in the printing unit.

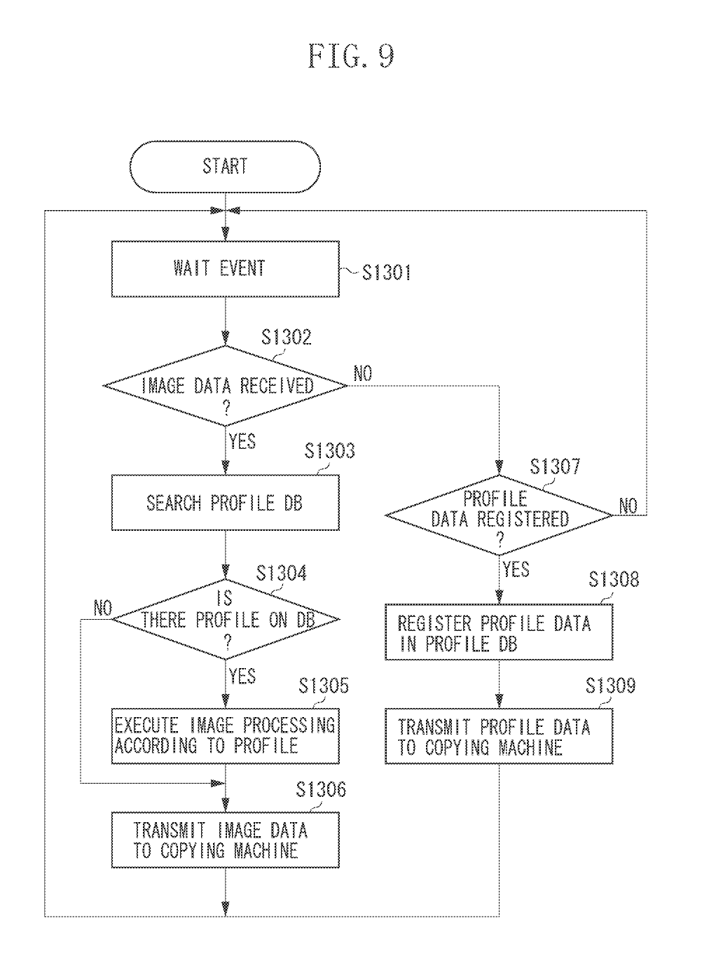

FIG. 9 is a flowchart illustrating processing executed in an external apparatus. The flowchart in FIG. 9 illustrates processing executed in the external apparatus 300 or 400, which is a PC for a user, in the external apparatuses. In the description below, the external apparatus 300 will be used as an example. A CPU 301 executes programs stored in a memory 303 in the external apparatus 300 and processes each step in FIG. 9.

In step S1301, the external apparatus 300 wait until any event occurs. When an event occurs, processing proceeds to step S1302. In step S1302, the external apparatus 300 determines whether the event which occurred is reception of image data transmitted from the copying machine 100. When the event is the reception of image data, processing proceeds to step S1303. Otherwise processing proceeds to step S1307.

In step S1303, the external apparatus 300 searches a profile DB 320 based on a user ID added to the image data and transmitted from the copying machine 100. In step S1304, the external apparatus 300 determines whether the profile is registered. In step S1305, as a result of the determination, when there is only one profile (image processing setting and parameters) corresponding to the user ID, an image processing application 310 executes image processing according to the identified profile. When a plurality of profiles is registered to the same user ID, the external apparatus 300 selects a profile based on a profile number transmitted from the copying machine 100, and the image processing application 310 executes image processing according to the selected profile. In step S1306, the external apparatus 300 transmits the image data, on which image processing is performed, to the copying machine 100. On the other hand, when the external apparatus 300 determines, in step S1304, that the profile is not registered (NO in step S1304), in step S106, the external apparatus 300 transmits the image data, on which the image processing is not performed, to the copying machine 100.

In step S1307, the external apparatus 300 determines whether a content of a event is a registration instruction of profile data by a user. When there is a registration instruction of profile data, processing proceeds to step S1308. In step S1308, the external apparatus 300 registers the input profile data in the profile DB 320. In step S1309, the external apparatus 300 transmits, to the copying machine 100, the profile data registered in S1308, a user ID, and a profile number if there is a plurality of profile data. As described above, since the copying machine 100 transmits the profile data received from the external apparatus 300 to the external apparatus 200 (server), the profile data registered in step S1308 is also registered in the external apparatus 200 (server).

As for the above description, the external apparatus including the image processing application realizes a extended copy function by cooperating with the copying machine 100. More specifically, the external apparatus performs image processing on image data according to a profile designated by the copying machine 100, and replies the image data after image processing to the copying machine 100.

In addition, in the example in FIG. 9, the profile data registered in the external apparatus 300 is transmitted to the server via the copying machine 100. However, if the external apparatus 300 can previously get an address of the server, the profile data can be transmitted directly to the server.

In FIG. 9, an operation of the external apparatus 300 which is a PC for a user is described. However, the external apparatus 200, which is a server, is different from the external apparatus 300 in the processing not including steps S1307, S1308, and S1309. Instead of these steps, the server executes a step to receive profile data from the copying machine 100, and a step to register the received profile data in the profile DB 220 in the server. Other processing (from steps S1301 to S1306) of the external apparatus 200 is similar to the processing of the external apparatus 300.

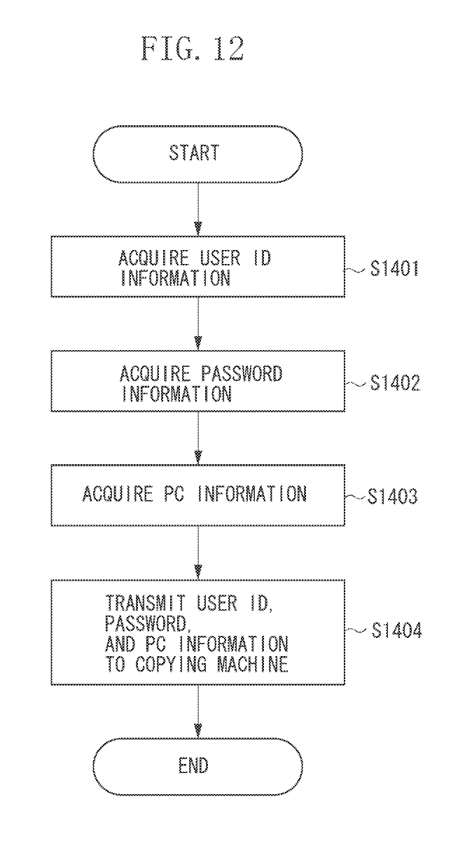

FIG. 12 is a flowchart illustrating processing executed in the external apparatus. The flowchart in FIG. 12 illustrates processing executed in the external apparatus 300 or 400, which is a PC for a user, in external apparatuses. In the description below, the external apparatus 300 will be used as an example. The CPU 301 executes programs stored in the memory 303 of the external apparatus 300 and processes each step in FIG. 12.

The steps in FIG. 12 are executed when the image processing application 310 is installed in the external apparatus 300. In step S1401, ID information of a user is acquired. In step S1402, password corresponding to the user ID is acquired. If the user ID and the password information can not be acquired from an operating system (OS) on the external apparatus 300, the user can input the user ID and the password. In step S1403, external apparatus information of the external apparatus 300 is acquired. The external apparatus information is information of a host name and an IP address. In step S1404, the user ID, the password, and the external apparatus information are transmitted to the copying machine 100. As a result, necessary information is registered in the user information database in the copying machine 100.

The present exemplary embodiment can be variously modified. For example, the external apparatus 300 or 400 as a PC of general users can have functions of the external apparatus 200 as a server. In other words, a profile data registered in an external apparatus can be not only registered in a server but also in another external apparatus. More specifically, in the example in FIG. 10, the external apparatus of “P2007-A300.cano.co.jp”, “P2009-A458.cano.co.jp”, and “P2008-Server01.cano.co.jp” share the same profile database. Accordingly, when there is not an external apparatus corresponding to an input user ID or such an external apparatus is unusable, a user can select the other external apparatus, in addition to an external default apparatus (server).

In the present exemplary embodiment, a copying machine is used as an example of an image processing apparatus. However, a multifunctional peripheral and a facsimile can be used. Further, a PC or a server is used as an example of an external apparatus. However, an image processing apparatus such as a copying machine, a multifunctional peripheral, or a facsimile can be used as the external apparatus. That is, a copying machine not capable of executing specific image processing cooperates with a copying machine capable of executing the image processing, so that the processing described in the present exemplary embodiment can be performed.

### Other Embodiments

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium). In such a case, the system or apparatus, and the recording medium where the program is stored, are included as being within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-274956 filed Dec. 2, 2009, which is hereby incorporated by reference herein in its entirety.

What is claimed is:

1. An apparatus comprising:
a determination unit configured to determine an external apparatus corresponding to a user authenticated by an authentication method for authenticating a user, as an external apparatus to be used in a plurality of the external apparatuses;
a reading unit configured to read a document and generate image data;
a transmission unit configured to transmit the generated image data to the determined external apparatus;
a receiving unit configured to receive image data from the external apparatus, wherein image processing is performed to the image data in the external apparatus; and
a printing unit configured to print using received image data.

2. The apparatus according to claim 1, further comprising:
a registration unit configured to relate user information for identifying the user to external apparatus information for identifying the external apparatus, and register the information.

3. The apparatus according to claim 1,
wherein the determination unit determines an external apparatus registered relating to the user information of an authenticated user, as an external apparatus to be used.

4. The apparatus according to claim 3, wherein when the external apparatus is not registered relating to user information of the authenticated user, or when the external apparatus is unusable, the determination unit determines an identified external apparatus previously registered in the apparatus, as an external apparatus to be used.

5. The apparatus according to claim 4, further comprising:
a display unit configured to display whether the determination unit determines the external apparatus corresponding to the user as an external apparatus to be used or determines the identified external apparatus previously registered as the external apparatus to be used.

6. The apparatus according to claim 5, wherein the plurality of the external apparatuses includes at least one or more PC for the user, and
wherein the identified external apparatus previously registered in the image processing apparatus is a server.

7. The apparatus according to claim 1, wherein the transmission unit transmits, to the determined external apparatus, the image data and information for identifying profile data indicating a content of image processing to be performed on the image data.

8. The apparatus according to claim 1, further comprising:
a transfer unit configured to transfer profile data indicating a content of image processing to be performed on the image data, to an identified external apparatus previously registered in the apparatus, when the transfer unit receives the profile data from any one of the plurality of the external apparatuses.

9. A method comprising:
determining an external apparatus corresponding to a user authenticated by authentication processing for authenticating a user as an external apparatus to be used in a plurality of the external apparatuses;
reading a document and generating image data;
transmitting the generated image data to the determined external apparatus;
receiving image data from an external apparatus, wherein image processing is performed on the image data in the external apparatus; and
printing using the received image data.

10. The method according to claim 9, further comprising relating user information for identifying the user to external apparatus information for identifying the external apparatus, and registering the information.

11. The method according to claim 9, further comprising determining an external apparatus registered relating to the user information of an authenticated user, as an external apparatus to be used.

12. The method according to claim 11, further comprising determining an identified external apparatus previously registered in the apparatus, as an external apparatus to be used when the external apparatus is not registered relating to user information of the authenticated user, or when the external apparatus is unusable.

13. The method according to claim 12, further comprising displaying determining the external apparatus corresponding to the user as an external apparatus to be used or determining the identified external apparatus previously registered as the external apparatus to be.

14. The method according to claim 9, further comprising transferring profile data indicating a content of image processing to be performed on the image data, to an identified external apparatus previously registered in the apparatus, when the profile data is received from any one of the plurality of the external apparatuses.

15. A computer-readable storage medium storing a computer-executable program of instructions for causing a computer to perform a method, comprising:
determining an external apparatus corresponding to a user authenticated by authentication processing for authenticating a user as an external apparatus to be used in a plurality of the external apparatuses;
reading a document and generating image data;
transmitting the generated image data to the determined external apparatus;
receiving image data from the external apparatus, wherein image processing is performed on the image data in the external apparatus; and
printing using the received image data.

16. The computer-readable storage medium according to claim 15, further comprising relating user information for identifying the user to external apparatus information for identifying the external apparatus, and registering the information.

17. The computer-readable storage medium according to claim 15, further comprising determining an external apparatus registered relating to the user information of an authenticated user, as an external apparatus to be used.

18. The computer-readable storage medium according to claim 17, further comprising determining an identified external apparatus previously registered in the apparatus, as an external apparatus to be used when the external apparatus is not registered relating to user information of the authenticated user, or when the external apparatus is unusable.

19. The computer-readable storage medium according to claim 18, further comprising: displaying determining the external apparatus corresponding to the user as an external apparatus to be used or determining the identified external apparatus previously registered as the external apparatus to be used.

20. The computer-readable storage medium according to claim 15, further comprising transferring profile data indicating a content of image processing to be performed on the image data, to an identified external apparatus previously registered in the apparatus, when the profile data is received from any one of the plurality of the external apparatuses.
